(19) United States
(12) Patent Application Publication
(10) Pub. No.: US 2025/0330769 A1
(43) Pub. Date: Oct. 23, 2025

(54) DISTRIBUTED INTERACTIVE BINAURAL RENDERING

(71) Applicant: DOLBY LABORATORIES LICENSING CORPORATION

(72) Inventors: Dirk Jeroen BREEBAART, North Sydney (AU); David S. McGRATH, Rose Bay (AU)

(73) Assignee: DOLBY LABORATORIES LICENSING CORPORATION, (US)

(21) Appl. No.: 18/864,497

(22) PCT Filed: May 9, 2023
(86) PCT No.: PCT/US2023/021481

§ 371 Date: Nov. 8, 2024

(51) Int. Cl. H04S 7/00

(52) U.S. Cl. CPC H04S 7/304; H04S 2420/01

(57) ABSTRACT

The present disclosure relates to a method, system and computer program product for processing audio. The method comprises receiving at least one input audio signal and producing a main rendered presentation and an additional rendered presentation, each rendered presentation being associated with a listener orientation and/or position. The method further comprises determining transformation parameters for transforming the main rendered presentation to the additional rendered presentation and determining a deviation value based on the orientation and/or position of the user and the listener orientations and/or positions. The method further comprises determining modified transformation parameters based on the transformation parameters and the deviation value and applying the modified transformation parameters to the main rendered presentation to generate an output presentation associated with the orientation and/or position of the user.

### CROSS-REFERENCE TO RELATED APPLICATIONS

This application claims priority to U.S. Provisional Application No. 63/340,181 filed on May 10, 2022, which is incorporated by reference in its entirety.

### TECHNICAL FIELD OF THE INVENTION

The present invention relates to a method for distributed rendering of audio signals.

### BACKGROUND OF THE INVENTION

Binaural audio content, e.g. in the form of stereo audio signals intended for playback on headphones or on loudspeaker systems with crosstalk cancellation, is becoming more and more popular. For example, object-based audio content can be rendered as a binaural stereo presentation for headphones using Head-Related Transfer Functions (HRTFs). Object-based audio content comprises one or more audio objects that are associated with an, optionally time-variant, position in three-dimensional space. For example, an audio object may be intended to be perceived by listener as an audio object which is to the right of the listener, above the listener, or moving along a trajectory around the listener. Object-based audio can therefore provide acoustic effects which enhance immersion for listeners.

HRTFs have been developed which, as a function of the orientation and/or position of a listener's head, describe inter-aural time differences, inter-aural level differences, reflections occurring in the human ear and frequency response of the human ear. Using such HRTFS, binaural audio signals can be generated for any arbitrary stationary or dynamic arrangement of audio objects in a three-dimensional space. Additionally, room reflections and/or reverberation is typically added to create a sense of perceived distance and space.

In some cases, the rendering of object-based audio content is adapted in substantially real-time based on the orientation and/or position of the listener so as to make the audio objects fixed to the environment instead of being fixed to the listener's head. Accordingly, as a listener moves his/her head the rendering is adapted such that the acoustic image is correspondingly shifted making the listener perceive that the audio objects are fixed in space rather than fixed to his/her head. As an example, the listener is first presented with an audio presentation in which an audio object is rendered to be perceived as being located to the right of the listener. If the listener turns around and faces the opposite direction, this orientation change is registered by an orientation detector which in turn provides this information to a render which modifies the rendering to provide a modified presentation in which the audio object is presented to be perceived as being located to the left of the listener. An effect of this is that the audio objects will appear as if they are fixed in listener's environment, with the listener being able to move and/or reorient himself/herself inside this space. This form of orientation and/or position modified rendering, sometimes referred to as interactive binaural rendering, is especially useful in gaming applications, extended reality (XR) applications, augmented reality (AR) applications and virtual reality (VR) applications.

### GENERAL DISCLOSURE OF THE INVENTION

A drawback with the existing solutions for listener orientation and/or position based audio rendering in substantially real-time is that rendering is associated with high requirements for data transmission bandwidth and processing power, which in turn increases the power consumption of the device performing the rendering. At the same time, to enable rendering of a convincing audio image including audio objects that appear to be fixed in space, or moving along a trajectory that is fixed in space, rather than fixed to the head of the listener, it is important to keep the latency, that is, the time delay between a listener changing head orientation and/or position and the associated modification in the audio presentation, very low, typically in the order of tens of milliseconds.

A first challenge therefore lies in providing an orientation and/or position based rendering process which provides sufficiently low latency and responds quickly to any changes in listener orientation and/or position. The latency between a change in orientation and/or position and the presentation of a modified audio presentation to the listener should ideally be substantially less than 100 ms since a latency in the order of 17 ms could be noticeable for many listeners. Such low latency is however difficult to realize in practice due to the inherent delay introduced by the rendering process itself, as well as the (typically wireless) transmission of sensor and audio data from an orientation tracking device worn by the user and a system, service or computer configured to perform the audio rendering.

To reduce the latency, the orientation and/or position tracking device, audio renderer and loudspeaker may be integrated into a same wearable device (e.g. earbuds or VR headsets). However, a second challenge then emerges related to the computational power required for substantially real-time orientation/position based rendering that responds rapidly to listener orientation and/or position changes, and the associated high electrical power consumption. Object-based audio may include a multitude of assets representing ambiance, point sound sources, sound effects, dialog and other important elements, which all need to be rendered in real-time in response changes in listener orientation and/or position which can occur suddenly and be very rapid (for example due to a listener quickly turning around, looking up and down or walking around in an environment). Wearable devices such as VR headsets, smart glasses, earbuds or glasses generally do not have the required processing power nor battery capacity to sustain this audio rendering for very long. In many applications, therefore, the orientation and/or position information is conveyed from a wearable device to a more powerful companion device like a phone, tablet, computer, gaming console or cloud computer (e.g., an edge server) which performs the rendering whereby the rendered presentation is conveyed back to the wearable device. However, communication between a companion device and wearable device greatly increases latency, especially if the communication happens over common wireless communication channels such as Bluetooth that can introduce significant latency.

To achieve sufficiently low latency a more capable wearable device can be used with enhanced processing performance and e.g. a larger battery. However to physically accommodate enhanced device capability, a third challenge then emerges since the wearable device becomes bulky and inconvenient to use (e.g., larger in volume and/or heavier to accommodate the necessary processing, power, and cooling components). Generally, the bandwidth for communicating with the wearable is also limited device and because multiple audio elements in object-based audio content requires significant bandwidth, some audio elements may need to be removed or compressed which degrades the Quality of Experience (QoE). Since it is difficult to achieve sufficient bandwidth with wireless communication some solutions resort to a wired data connection to the wearable device, however, this greatly impedes the flexibility of the wearable device making it difficult to use outdoors or difficult for the user to move around freely.

It is a purpose of the present disclosure to present a method for rendering audio content, especially object-based audio content, which responds to a change in listener orientation and/or position in substantially real time which overcomes or at least mitigates the problems with the prior solutions highlighted in the above.

According to a first aspect of the present invention there is provided a method of processing audio, comprising: receiving, at a first processing module, at least one input audio signal and producing, at the first processing module, a main rendered presentation and an additional rendered presentation, each rendered presentation being associated with a first and second listener orientation and/or position, respectively. The method further comprises determining, at the first processing module, transformation parameters for transforming the main rendered presentation to the additional rendered presentation and receiving, at a second processing module, the transformation parameters and the main rendered presentation generated by the first processing module. The method further comprises receiving, at the second processing module, user orientation and/or position data indicating the orientation and/or position of a user, determining, at the second processing module, an orientation and/or position deviation value based on the orientation and/or position of the user and the first and second listener orientation and/or position, determining, at the second processing module, modified transformation parameters based on the transformation parameters and the orientation and/or position deviation value and applying, at the second processing module, the modified transformation parameters to the main rendered presentation to generate an output presentation associated with the orientation and/or position of the user.

That is, the first processing module preemptively renders at least two presentations associated with different listener orientations and/or positions and determines, for each presentation except one (the main presentation), transformation parameters that can be used to transform the main presentation to the at least one additional rendered presentation.

With a listener or user “orientation” it is meant the rotational orientation of an assumed listener's or a user's head. For example, an orientation may be defined by one or more of a pitch, yaw and roll angle. With a listener or user “position” it is meant the position of a listener's head or a user's head in one more of the directions forward/backward, left/right and up/down. For example, a position may be defined by a cartesian coordinate system with perpendicular X, Y and Z axis. It is understood that different listener orientations and/or positions may differ in in one of orientation and position or differ in both orientation and position. It is envisaged that some implementations only orientation changes (with one, two or three degrees of freedom) are considered while in other implementations only position changes (with one, two or three degrees of freedom) are considered.

The orientation and/or position deviation value may be a linear or non-linear distance between two orientations and/or positions. Additionally, the orientation and/or position deviation may be a perceptually weighted distance between two orientations and/or positions, as will be described in further detail in the below.

The transformation parameters may be updated for each time-frequency tile of a time-frequency representation. As will be described in the below, for audio presentations with two channels, each set of transformation parameters may comprise as few as four or five transformation parameters (of which some may be complex valued), or even as few as two real-valued transformation parameters, which constitutes an amount of data that can be transmitted rapidly, with low latency. The transformation parameters are still sufficient to accurately describe an orientation/position transformation from a main presentation to an additional presentation and can be used to find modified transformation parameters (using e.g. interpolation) if the user orientation/position does not correspond to the orientation/position associated with additional presentation.

Thus, even though the transformation parameters are updated frequently, e.g. for each time-frequency tile, the transformation parameters represent only a small amount of data (compared to the hundreds or thousands of samples for representing a time-frequency tile of an audio channel) which can be transmitted efficiently to the second processing module.

Furthermore, application and/or modification of the transformation parameters is computationally efficient and can be performed rapidly, even on processing modules with limited processing power, meaning that the second processing module can be implemented on limited devices such as in such as headphones, earphones, wireless earbuds, true wireless earbuds, smart glasses or VR/AR/XR headsets. By receiving a rendered main presentation associated with a first listener orientation/position and transformation parameters associated with a second listener orientation/position the second processing module can rapidly modify and apply the transformation parameters to the main presentation to shift the presentation to the second listener orientation/position if this coincides better with the actual user orientation/position. It is also possible to modify the transformation parameters, e.g. using interpolation, prior to applying them to the main presentation to more accurately follow the user's orientation/position.

With this method, the rendering of the input audio signal can be shifted based on the orientation/position of the user such that the user is presented with an audio presentation which appears to be fixed in space. As an illustrative example, the audio assets are associated with music coming from a virtual stage straight in front of the listener and the user is listening to these audio assets using earphones while standing in a physical space. If the user turns his or her head to the right, the rendering is adjusted such that the listener is presented with an audio presentation that makes it appear as the music is coming from the left. This is an example of modifying a presentation to follow the user's orientation relative the virtual three-dimensional space of the audio assets. If the listener moves towards or away from the virtual stage the user may be presented with an audio presentation wherein the music becomes louder or weaker. This is an example of modifying a presentation to follow the user's position relative the virtual three-dimensional space of the audio assets. One or more audio assets may also comprise an audio object moving along a trajectory in the virtual three-dimensional space. By shifting the rendering of the audio assets based on the orientation/position of the user it is possible to provide the listener with an audio presentation that makes the listener perceive that the trajectory along which the audio object moves is fixed in the virtual three-dimensional space.

In some implementations, the first and second listener orientation and/or position are different yaw orientations at respective first and second pitch orientations and the method further comprises obtaining, at the second processing module, reduced transformation parameters associated with a third pitch orientation, the reduced transformation parameters being configured to transform the main rendered presentation or the additional rendered presentation to a pitched rendered presentation with the third pitch orientation and applying, at the second processing module, based on the orientation deviation, the reduced transformation parameters to the main rendered presentation to generate the output presentation.

That is, each set of transformation parameters may be associated with a respective orientation which differs in yaw (the user looking left or right) at a predetermined pitch angle (the user looking up or down) and the transformation parameters capture the interaural effects which are very noticeable for varying yaw angles. On the other hand, to span different pitch angles a set of reduced transformation parameters having fewer parameter values (e.g. one real gain value per channels) compared to the (non-reduced) transformation parameters is conveyed for a plurality of pitch angles that deviates from the predetermined pitch angle, for each yaw angle. Accordingly, by considering that the sensitivity to audio presentation shifts in yaw differs from presentation shifts in pitch it is possible to reduce the amount of information that is conveyed to the second processing module without reducing the Quality of Experience, QoE.

According to a second aspect of the present invention there is provided a computer program product comprising instructions which, when the program is executed by a computer, causes the computer to carry out the method according to the first aspect.

According to a third aspect of the present invention there is provided a system comprising a first processing module communicating with a second processing module, wherein the first and second processing modules are configured to carry out the method according to the first aspect.

The computer program product and system according to the second and third aspects features the same or equivalent benefits as the method according to the first aspect. Any functions described in relation to a method may have corresponding features in a system or computer program product, and vice versa.

### BRIEF DESCRIPTION OF THE DRAWINGS

Aspects of the present invention will be described in more detail with reference to the appended drawings, showing currently preferred embodiments.

FIG. 1 shows a distributed audio processing system according to some implementations.

FIG. 2 illustrates schematically a plurality of distributed listener orientations/positions according to some implementations.

FIG. 3 illustrates schematically a plurality of distributed listener orientations/positions and a detected user orientation/position that differs from two of the listener orientations/positions along the X- or yaw-axis, according to some implementations.

FIG. 4 illustrates schematically a plurality of distributed listener orientations/positions and a detected user position/orientation that differs from two of the listener orientations/positions along the Y- or pitch-axis, according to some implementations.

FIG. 5 illustrates schematically a plurality of distributed listener orientations/positions and two detected user orientations/positions according to some implementations.

FIG. 6 illustrates schematically distributed listener orientations/positions, wherein listener orientations separated in yaw are associated with transformation parameters and wherein for each yaw orientation axis, there are multiple listener pitch orientation associated with reduced transformation parameters, according to some implementations.

FIG. 7 shows a multi-presentation encoder communicating with an interactive renderer using a parameter encoder and parameter decoder according to some implementations.

FIG. 8 is a flow-chart describing a method for processing audio according to some implementations.

FIG. 9 is a flow-chart describing the process of determining transformation parameters and reduced transformation parameters according to some implementations.

FIG. 10 is a flow-chart describing the process of conveying transformation parameters to the interactive renderer according to some implementations.

### DETAILED DESCRIPTION OF CURRENTLY PREFERRED EMBODIMENTS

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, an AR/VR wearable, automotive infotainment system, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (e.g., computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

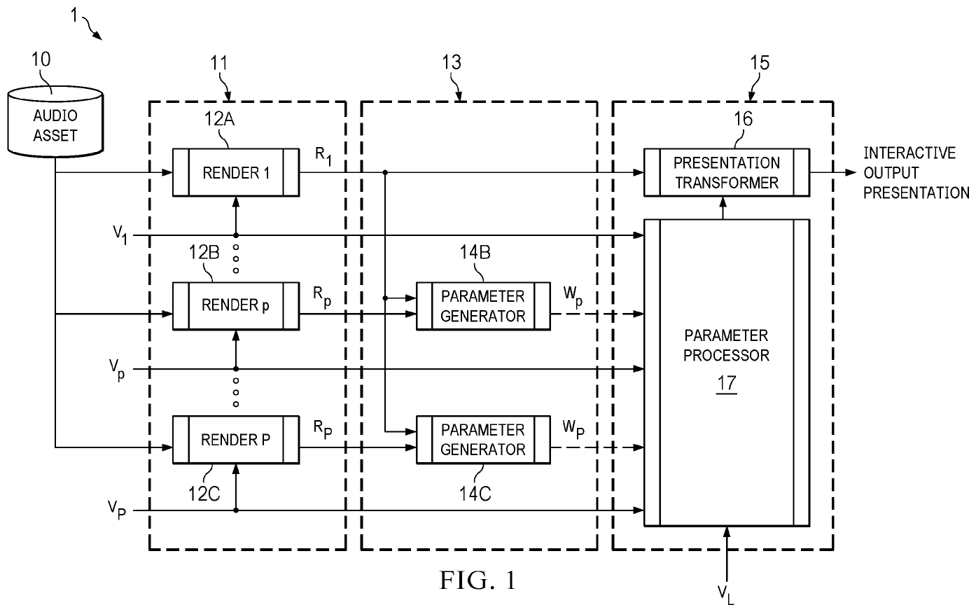

FIG. 1 depicts a distributed rendering system 1 according to some implementations. The distributed rendering system 1 comprises three sub-systems 11, 13, 15. More specifically, the distributed rendering system 1 comprises a multi-presentation renderer module 11, a multi-presentation encoder 13 and an interactive renderer 15. At least one of the sub-systems 11, 13, 15 is implemented in a device that is separate from the device which implements at least one of the other sub-systems 11, 13, 15 meaning that the full rendering process is distributed across at least two devices which communicate with each other. Two of the sub-systems 11, 13, 15 may be implemented in the same device wherein the remaining sub-system 11, 13, 15 is implemented by a separate device.

As will be described in the below, the amount of input data and the computational complexity of the processing performed varies between the different sub-systems. A benefit with the distributed rendering system 1 of FIG. 1 is that the amount of data that is conveyed to the interactive renderer 15 is minimized while the interactive renderer 15 also is associated with the least complex processing out of the three sub-systems. This makes the interactive renderer 15 well suited for implementation in computationally limited and power constrained devices, such as wearable devices whereas the other two sub-systems 11, 13 can be implemented in computationally more capable devices, such as a smartphone, computer or gaming console that communicates with the device implementing the interactive renderer 15.

Accordingly, in some implementations, the multi-presentation renderer 11 and multi-presentation encoder 13 are implemented on a high-performance device (or optionally on two different high performance devices communicating with each other) whereas the interactive renderer 15 is implemented on a separate constrained device, wherein the high performance device is configured to communicate with the constrained device. Examples of a high performance device may be a smartphone, tablet, computer (e.g. a desktop or a laptop), gaming console, cloud computer or server. Examples of a constrained device comprises a pair of headphones, earphones, wireless earbuds, smart glasses, true wireless earbuds or VR/AR/XR headsets. It may be beneficial for the constrained device to communicate with the high performance device using a wireless connection (e.g. WiFi or Bluetooth) although it is also envisaged that the communication could also occur over a wired connection.

The processing performed by the multi-presentation renderer 11, multi-presentation encoder 13 and interactive renderer 15 will now be described in further detail with reference to FIG. 1.

The multi-presentation renderer 11 is configured to render at least two audio presentations based on one or more audio assets 10. The audio presentations are labeled R₁, . . . . Rₚ, . . . , R_{P} meaning that the multi-presentation renderer 11 in general renders P number of presentations wherein P≥2. Each of the at least two presentations R₁, . . . , R_{P} are associated with a different listener orientation and/or position with respect to the audio assets 10. The term “listener orientation and/or position” is used to denote an assumed listener orientation/position with respect to the audio assets 11.

The audio assets 10 may comprise one or more spatialized audio objects often referred to simply as audio objects. An audio object is an audio signal associated with a spatial attribute such as a position in a three dimensional space or a direction of incidence. How one or more audio objects should be rendered to form an audio presentation depends on the orientation and/or position of an assumed listener relative to the audio objects.

The multi-presentation renderer 11 selects a plurality of possible listener orientations/positions labeled V₁, V₂, . . . , V_{P} relative the audio assets 10 and renders, for each of the plurality of listener orientations/position V₁, V₂, . . . , V_{P}, an individual presentation R₁, . . . , R_{P}. For example, the plurality listener orientations/positions V₁, V₂, . . . , V_{P} are selected to span a range of orientations (indicated by angles pitch, yaw and roll and/or positions (indicated by cartesian coordinates X, Y, Z) in the three-dimensional space of the audio assets. It is noted that the multi-presentation renderer 11 may select the listener orientations/positions without regard to any actual measured orientation/position of the user. That is, the multi-presentation renderer 11 renders multiple possible presentations that would correspond to a listener oriented at V₁, V₂, . . . , V_{P} however in general none of these positions will correspond exactly to the actual user orientation V_{L}.

For example, each audio presentation R₁, . . . , R_{P} is a pair of binaural audio signals extracted using a respective HRTF, wherein the orientation/position of the HRTF with respect to the audio assets 10 is different between the respective HRTFs.

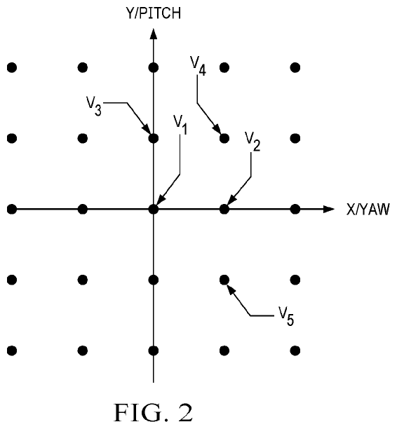

That is, the multi-presentation renderer 11 obtains at least two orientations V₁, . . . . Vₚ, . . . , V_{P} and renders, for each orientation, a corresponding presentation R₁, . . . . Rp, . . . . R_{P} based on the audio assets 10. In some implementations, as shown schematically in FIG. 2, the orientations/positions V₁, . . . . Vₚ, . . . , V_{P} span different combinations of pitch and yaw angles at a predetermined point in the three-dimensional space of the audio assets 10. For instance, orientation V₁ indicates a pitch of 0 degrees and yaw of 0 degrees, orientation V₂ indicates a pitch of 0 degrees and a yaw of 5 degrees, orientation V₃ indicates a yaw of 5 degrees and a yaw of −5 degrees etc. Similarly, the orientations/positions may be selected to span a variety of X, Y, Z positions.

For each orientation/position V₁, . . . , V_{P} a separate audio presentation R₁, . . . , R_{P} is rendered. To achieve this, the multi-presentation renderer 11 may comprise a plurality of renderers 12a, 12b, 12c each associated with an individual orientation/position V₁, . . . , V_{P} and configured to render an associated presentation R₁, . . . , R_{P} based on the orientation/position V₁, . . . , V_{P} and the audio assets 10. In some implementations, each presentation R₁, . . . , R_{P} is a binaural audio presentation suitable for playback on headphones comprising two audio channels, a left audio channel and a right audio channel. However, it is envisaged that the presentations also could be other types of presentations, such as a mono presentation, stereo presentation or surround presentation (e.g. a 5.1 or 7.1 presentation).

The multi-presentation renderer 11 renders at least two presentations, R₁ and R₂. In general, it is beneficial if the multi-presentation renderer 11 renders a large number of presentations, such as at least ten presentations (P≥10), at least twenty presentations (P≥20) or at least fifty presentations (P≥50) to span a large area of listener orientations/positions and/or ensure that the distance between two listener orientations/positions is not too large.

The multi-presentation renderer 11 conveys the rendered presentations R₁, . . . , R_{P} to the multi-presentation encoder 13.

The multi-presentation encoder 13 receives all P presentations R₁, . . . , R_{P} from the multi-presentation renderer 11 and determines, for all but one presentation, a set of transformation parameters Wₚ. That is, the multi-presentation encoder 13 designates one of the P presentations as the main presentation and determines, for all (at least one) remaining presentations associated transformation parameters. The remaining presentation(s) are referred to as additional presentations. In the following, and without loss of generality, presentation R₁ is assumed to be the main presentation meaning that presentation R₂, . . . , R_{P} are additional presentations R₂, . . . , R_{P} and associated transformation parameters W₂, . . . , W_{P} are determined for each of the remaining presentations R₂, . . . . R_{P}.

Each set of transformation parameters Wₚ, wherein the index p ranges from 2 to P with P≥2, is configured to transform the main presentation R₁ at listener orientation V₁ to presentation Rₚ at position Vₚ.

To determine the transformation parameters Wₚ, the multi-presentation encoder 13 comprises one or more parameters generators 14b, 14c wherein each parameters generator 14b, 14c takes two presentations as input, the main presentation R₁ and a respective one of the additional presentations R₂, . . . . R_{P}. Each parameter generator 14b, 14c generates transformation parameters W_{P} that transforms the main presentation R₁ into the respective additional presentations R_{P}.

In following, the operations of a parameter generator 14b and properties of the transformation parameters will be described in detail. It is understood that other types of transformation parameters could also be determined and used analogously, and that any other parameter generator 14a may operate completely analogously to the parameter generator 14b.

As mentioned in the above, the parameter generator 14b receives two rendered presentations, the main presentation, labeled R₁ and an additional rendered presentation Rₚ. The format of the two presentations R₁, R_{P} is the same, e.g., the main presentation R₁ and additional rendered presentation Rₚ are both binaural audio signals, both stereo audio signals, both mono audio signals, or both surround audio signals (e.g. 5.1 signals). In the following exemplary implementation it will be assumed that the format of the presentations R₁, Rₚ is a binaural format comprising two audio channels however it is noted that the same process can be performed analogously for presentations of other formats.

Each rendered presentation R₁, Rₚ comprises a left channel and a right channel (forming a binaural pair of signals). Accordingly, for the main presentation R₁ and the additional presentation Rₚ it holds

$${R}_{1} = [ \begin{matrix}{\vec{y}}_{l , 1} \\ {\vec{y}}_{r , 1}\end{matrix} ] \qquad Eq . 1$$

$${R}_{2} = [ \begin{matrix}{\vec{y}}_{l , p} \\ {\vec{y}}_{r , p}\end{matrix} ] \qquad Eq . 2$$

where [symbol] _{l,p} represents the left channel of the p-th presentation and [symbol] _{r,p} represents the right channel of the p-th presentation. In some implementations, the parameter generator 14b determines a transformation matrix \hat{M}_{P} such that

$$[ \begin{matrix}{z}_{l , p} [ n ] \\ {z}_{r , p} [ n ]\end{matrix} ] = {\hat{M}}_{P} [ \begin{matrix}{y}_{l , 1} [ n ] \\ {y}_{r , 1} [ n ]\end{matrix} ] \qquad Eq . 3$$

wherein [z_{l,p}[n], z_{l,p}[n]]^{T} is a reconstructed presentation \hat{R}ₚ at orientation/position Vₚ and index n indicates the audio sample index of the respective channel. Accordingly, \hat{R}ₚ has been reconstructed from R₁ at orientation/position V₁ using the transformation matrix \hat{M}_{P} wherein ideally \hat{R}ₚ≅Rₚ.

To determine the transformation matrix \hat{M}_{P}, the parameter generator may determine an initial least squares solution \hat{M}_{P} by minimizing the root-mean-square error between the presentation Rₚ and the main presentation R₁ with the matrix \hat{M}_{P} applied. That is, the initial least squares solution \hat{M}_{P} may be determined as

$${\hat{M}}_{p} = arg ( min ( ‖ {\hat{M}}_{p} [ \begin{matrix}{y}_{l , 1} [ n ] \\ {y}_{r , 1} [ n ]\end{matrix} ] - [ \begin{matrix}{y}_{l , p} [ n ] \\ {y}_{r , p} [ n ]\end{matrix} ] ‖ ) ) . \qquad Eq . 4$$

The initial least squares solution \hat{M}_{P} from equation 4 may be determined iteratively. Alternatively, the initial least squares solution \hat{M}_{P} can be expressed as a closed-form solution. For instance, if the covariance matrix of the channels of a presentation, e.g. [ [symbol] ₚ[n], [symbol] _{l,p}[n]]^{T}, is denoted R_{y,p,p} and the correlation matrix between two different presentations Rₚ₁ and Rₚ₂ is denoted R_{y,p1,p2} it can be shown that closed-form solution to equation 6 is given by:

$${\hat{M}}_{p} = {( {R}_{y , 1 , 1} + I ϵ )}^{- 1} {R}_{y , 1 , p} \qquad Eq . 5$$

with ϵ being a regularization parameter and I being the identity matrix. If the transformation matrix \hat{M}_{P} is applied directly to the main presentation R₁ an approximation \hat{R}ₚ of the presentation Rₚ is obtained as

$$[ \begin{matrix}{\hat{y}}_{l , p} [ n ] \\ {\hat{y}}_{r , p} [ n ]\end{matrix} ] = {\hat{M}}_{p} [ \begin{matrix}{y}_{l , 1} [ n ] \\ {y}_{r , 1} [ n ]\end{matrix} ] \qquad Eq . 6$$

with [ŷ_{l,p}[n], ŷ_{r,p}[n]]^{T} representing the channels of the approximation \hat{R}_{P} of the presentation Rₚ. This transformation matrix \hat{M}_{P} may be used as the transformation parameters Wₚ as it offers a transformation of the main presentation R₁ into an approximation of the presentation Rₚ. Accordingly, in some implementations the transformation parameters comprises the transformation matrix \hat{M}_{P} wherein the transformation matrix [symbol] is of size N-by-N, N being the number of audio channels in the presentation format of the main and additional rendered presentation R₁, R_{P} and [symbol] indicates a combination of the audio channels in the main presentation R₁ that resembles the additional presentation Rₚ. It is noted that the transformation matrix [symbol] may have complex valued elements and/or be a three dimensional matrix of size N×N×M wherein M is a plurality of real or complex filter samples.

In some implementations, a more accurate reconstruction of the additional presentation Rₚ is desired whereby an additional diagonal gain matrix G and/or decorrelation contribution gain g_{d,p} is determined and used to modify the transformation matrix \hat{M}_{P} to obtain an enhanced modified transformation matrix Mₚ. For instance, even though \hat{M}_{P} solves equation 4 its application to the main presentation R₁ may in some cases result in a covariance matrix which differs from that of the presentation Rₚ. The covariance matrix of the predicted presentation \hat{R}ₚ is given by R_{ŷ,p,p} which can be expressed as

$${R}_{\hat{y} , p , p} = {\hat{M}}_{p}^{*} {R}_{y , 1 , 1} {\hat{M}}_{p} \qquad Eq . 7$$

wherein R_{ŷ,p,p} may be different from the covariance matrix R_{y,p,p} of the actual presentation Rₚ. This deviance in the covariance matrix can be remedied by the diagonal gain matrix G and/or the decorrelation factor scaled with the decorrelation gain g_{d,p}. Specifically, a model for an enhanced reconstruction of R*ₚ from the main presentation R₁ is established as

$$[ \begin{matrix}{z}_{l , p}^{*} [ n ] \\ {z}_{r , p}^{*} [ n ]\end{matrix} ] = G {\hat{M}}_{p} [ \begin{matrix}{y}_{l , {p}_{o}} [ n ] \\ {y}_{r , {p}_{o}} [ n ]\end{matrix} ] + [ \begin{matrix}\vert {g}_{d , p} \vert \\ {g}_{d , p}\end{matrix} ] Ψ ( {y}_{l , {p}_{o}} [ n ] + {y}_{r , {p}_{o}} [ n ] ) \qquad Eq . 8$$

$$with$$

$${R}_{p}^{*} = [ \begin{matrix}{z}_{l , p}^{*} [ n ] \\ {z}_{r , p}^{*} [ n ]\end{matrix} ] , \qquad Eq . 9$$

$$G = [ \begin{matrix}{g}_{l , p} & 0 \\ 0 & {g}_{r , p}\end{matrix} ] , \qquad Eq . 10$$

$$and$$

$${G}_{d} = [ \begin{matrix}\vert {g}_{d , p} \vert \\ {g}_{d , p}\end{matrix} ] . \qquad Eq . 11$$

Wherein the function Ψ(⋅) represents a decorrelator that generates an input signal from an output signal according to the following two requirements:

$$〈 {Ψ ( x )}^{2} 〉 = 〈 {x}^{2} 〉 , \qquad Eq . 12$$

$$and$$

$$〈 Ψ ( x ) 〉 = 0 \qquad Eq . 13$$

with [symbol] ⋅ [symbol] representing the expected value operator.

From equation 8 it can be shown that, assuming g_{d,p}≤0, the resulting covariance matrix R_{z,p,p} of this enhanced prediction R*ₚ is given by

$${R}_{z , p , p} = {G}_{p}^{*} {\hat{M}}_{p}^{*} {R}_{y , {p}_{o} , {p}_{o}} {\hat{M}}_{p}^{*} {G}_{p} + {g}_{d , p}^{2} {σ}_{d}^{2} [ \begin{matrix}1 & - 1 \\ - 1 & 1\end{matrix} ] , \qquad Eq . 14$$

$$wherein$$

$${{σ}_{d}^{2} = 〈 ( {y}_{l , {p}_{o}} [ n ] + {y}_{r , {p}_{o}} [ n ] ) )}^{2} 〉 . \qquad Eq . 15$$

Accordingly, by setting appropriate values of the diagonal gain matrix G and g_{d,p} it is possible to ensure that covariance matrix R_{z,p,p} of this enhanced prediction R*ₚ equals the covariance matrix R_{y,p,p} of the true presentation Rₚ. It can be shown that a solution to this problem of R_{z,p,p}=R_{y,p,p} is found as:

$${g}_{d , p}^{2} = \frac{- B \pm √ D}{2 A} , \qquad Eq . 16$$

$${g}_{l , p}^{2} = \frac{{R}_{y , p , p} ( 1 , 1 ) - {g}_{d , p}^{2} {σ}_{d}^{2}}{{R}_{\hat{y} , p , p} ( 1 , 1 )} , \qquad Eq . 17$$

$$and$$

$${g}_{r , p}^{2} = \frac{{R}_{y , p , p} ( 2 , 2 ) - {g}_{d , p}^{2} {σ}_{d}^{2}}{{R}_{\hat{y} , p , p} ( 2 , 2 )} \qquad Eq . 18$$

$$wherein$$

$$[ \begin{matrix}A \\ B \\ C \\ D\end{matrix} ] = [ \begin{matrix}{σ}_{d}^{4} {ρ}^{2} - {σ}_{d}^{4} \\ - {ρ}^{2} {σ}_{d}^{2} ( {R}_{y , p , p} ( 1 , 1 ) + {R}_{y , p , p} ( 2 , 2 ) ) - 2 {σ}_{d}^{2} {R}_{y , p , p} ( 1 , 2 ) \\ {ρ}^{2} {R}_{y , p , p} ( 1 , 1 ) {R}_{y , p , p} ( 2 , 2 ) - {R}_{y , p , p} ( 1 , 2 ) \\ {B}^{2} - 4 AC\end{matrix} ] , \qquad Eq . 19$$

$$and$$

$${ρ}^{2} = \frac{{R}_{\hat{y} , p , p}^{2} ( 1 , 2 )}{{R}_{\hat{y} , p , p} ( 1 , 1 ) {R}_{\hat{y} , p , p} ( 2 , 2 )} . \qquad Eq . 20$$

An enhanced transformation matrix Mₚ is thus acquired as Mₚ=G \hat{M}ₚ and for a single presentation Rₚ the parameter generator 14b determines, as the transformation parameters Wₚ, either (A) the transformation matrix \hat{M}ₚ or (B) the enhanced transformation matrix Mₚ and the decorrelation gain g_{d,p}. This information is sufficient for accurate reconstruction of the presentation Rₚ from the main presentation R₁.

In some implementations, the procedure to determine the transformation matrix \hat{M}ₚ or enhanced transformation matrix Mₚ and a decorrelation gain gap is repeated for each time-frequency tile of the presentations R₁ and Rₚ. The parameter generator 14b determines an initial least square solution \hat{M}ₚ or enhanced transformation matrix Mₚ and a decorrelation gain g_{d,p} for each time-frequency tile of the respective presentation. Accordingly, the initial least square solution \hat{M}ₚ or enhanced transformation matrix Mₚ and a decorrelation gain g_{d,p} enables accurate reconstruction of the presentation Rₚ from R₁ even if the presentations vary over time and/or frequency.

It is noted that the elements of the transformation matrix \hat{M}ₚ or enhanced transformation matrix Mₚ may be complex valued. Additionally, it is noted that each element of the transformation matrix \hat{M}ₚ or enhanced transformation matrix Mₚ may be vector valued (e.g., forming a three-dimensional matrix) with each element defining a plurality of discrete real valued or complex filter samples defining an FIR filter.

In the above example, the presentations R₁, . . . . Rₚ are binaural audio signals with two channels. In such examples, \hat{M}ₚ and Mₚ are 2×2 matrices or (2×2×M matrices with M being the number of discrete filterbank samples). In general, for presentations with N channels, \hat{M}ₚ and Mₚ are N×N matrices or N×N×M matrices.

The transformation matrix \hat{M}ₚ or enhanced transformation matrix Mₚ and a decorrelation gain g_{d,p} are combined into a set of transformation parameters Wₚ for each presentation and time-frequency tile. For example, Wₚ={Mₚ, g_{d,p}} or Wₚ={\hat{M}ₚ} for each presentation and time-frequency tile.

The transformation parameters Wₚ for each presentation are transmitted alongside the main presentation R₁ to the interactive renderer 15. It is understood that a set of transformation parameters Wₚ requires much less data to transmit compared to the main presentation R₁. For example, the main presentation R₁ is associated with a time-frequency tile representation (e.g. STFT representation) with hundreds or thousands of complex-valued audio samples in a frame. On the other hand, the transformation parameters Wₚ associated with a presentation Rₚ only involves four (potentially complex) values if Wₚ={\hat{M}ₚ} or five values (out of which four are potentially complex) if Wₚ={Mₚ, g_{d,p}} per time-frequency tile per presentation. Assuming all STFT frequency audio samples in each frame would be grouped into 5 to 50 tiles or frequency bands for which transformation parameters Wₚ are calculated, the transformation parameters would comprise of approximately 25 to 250 parameter values, which is one to two orders of magnitude smaller than the audio samples in the main presentation. Aside from the reduction in the number of parameters, the accuracy of transformation parameters can typically be significantly less than the required accuracy of audio samples, which also contributes to a reduction in information when the transmitted data is digitally quantized. Accordingly, it is much more efficient to transmit an additional set of transformation parameters Wₚ compared to transmission of an additional presentation Rₚ.

The main presentation R₁ is received by the interactive renderer 15 alongside at least one set of transformation parameters Wₚ associated with an orientation/position Vₚ. As it may not be directly derivable from the transformation parameters Wₚ as such what the associated orientation/position Vₚ is, the orientation/position Vₚ may be explicitly indicated as a vector Vₚ accompanying each set of transformation parameters Wₚ. Alternatively, the orientations/positions V₁, . . . , V_{P} may be predetermined beforehand and stored locally in the interactive renderer 15.

With further reference to FIG. 2 it is schematically illustrated how the positions V₂, . . . , V_{P} are distributed to span a range of translational positions and/or rotational orientations. Positions V₁, V₂, V₃, V₄ exemplified in FIG. 2 are spread across different translational positions in an XY-plane and/or different rotational orientations in a Pitch-Yaw-plane. It is understood that additional orientations/positions could also be added in a third dimension (Z-axis or roll-axis) that is perpendicular to the XY-plane or Pitch-Yaw-plane shown in FIG. 2. Position V₁ is associated with the main presentation R₁ and for the remaining positions V₂, V₃, V₄ associated transformation parameters W₂, W₃, W₄ are available to the interactive renderer 15 for transforming the main presentation R₁ to a presentation associated with one of the positions V₂, V₃, V₄.

The interactive renderer 15 also receives user orientation and/or position data indicating the orientation/position V_{L} of a user. The listener orientation/position data may be received from an orientation/position detector such as a head-tracking detector. Examples of orientation/position detectors include magnetic sensors, gyroscopic sensors, GPS receivers, accelerometers and UV/IR/visible light sensors (e.g. a camera sensor). The orientation/position detector may be included in the same device as the interactive renderer 15 enabling low latency communication between the orientation detector and the interactive render 15. For example, the orientation detector and interactive renderer 15 may be comprised in as set of earphones or earbuds. Additionally or alternatively, the orientation/position tracker is provided externally of the device implementing the interactive renderer 15 wherein the orientation/position tracker transmits the user orientation and/or position data to the interactive renderer 15. An example of an external orientation tracking device is one or more cameras provided in the user's environment that tracks the orientation/position of the user's head, e.g. using motion tracking or face recognition. Another example of an external orientation tracker is the user wearing one or more light emitting devices that emit an IR, UV or visible light that is tracked by one or more IR, UV or visible light sensors provided in the environment, wherein the orientation/position of the light emitting devices is associated with the orientation/position of the user's head.

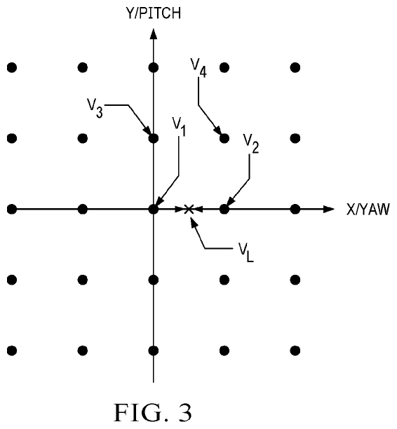

As shown in FIG. 3, the user orientation/position V_{L} may deviate from one or more of the orientations/positions V₁, V₂, V₃, V₄ for which transformation parameters W₂, W₃, W₄ have been generated. In general, the user orientation/position V_{L} may vary continuously, or with much finer granularity, compared to the granularity of the orientations/positions V₁, V₂, V₃, V₄. For example, the user has moved his or her head to face a yaw orientation different from the yaw orientation V₁ of the main presentation R₁ and the yaw orientation of the presentation R₂ associated with orientation V₂ for which transformation parameters are available. To this end, the interactive renderer 15 comprises a parameter processor 17 configured to determine modified transformation parameters W_{L} based on a deviation value between the orientation/position of the user V_{L} and at least one of: the orientation/position V₁ associated with the main presentation R₁ and the orientation/position V₂, V₃, V₄ associated with the transformation parameter sets W₂, W₃, W₄.

Determining modified transformation parameters W_{L} may comprise selecting the transformation parameters associated with an orientation/position V₁, V₂, V₃, V₄ which is the smallest distance (e.g., closest) to the listener orientation/position V_{L} and using these parameters to transform the main presentation R₁. Alternatively, determining modified transformation parameters W_{L} may comprise interpolating between at least two sets of transformation parameters W₁, W₂, W₃, W₄ associated with an orientation/position V₁, V₂, V₃, V₄ which is in the proximity of the listener orientation/position V_{L}.

The deviation value between two listener orientations/positions V₁, V₂, V₃, V₄ and/or between a listener orientation/position V₁, V₂, V₃, V₄ and the user orientation V_{L} may be determined as the linear or non-linear distance between the orientations/positions. For example, each orientation/position V₁, V₂, V₃, V₄, V_{L} may be represented as a point or vector in a coordinate system and the deviation value of two orientations/positions V₁, V₂, V₃, V₄, V_{L} may be determined simply as the Euclidean distance, cosine similarity, haversine distance, etc. between two points or vectors.

Additionally, the deviation value between two listener orientations/positions V₁, V₂, V₃, V₄ and/or between a listener orientation/position V₁, V₂, V₃, V₄ and the user orientation V_{L} may be a perceptually weighted distance. That is, determining the deviation value between two orientations/positions V₁, V₂, V₃, V₄, V_{L} may comprise weighting the different components of the distance (expressed in e.g. pitch-, yaw-, roll-angle and/or X-, Y-, Z-distance) differently based on the expected perceptual impact on the rendered presentation.

For example, as will be explained in detail in the below, orientation changes in yaw (i.e. the user looking left and right) may be perceptually more significant compared to orientation changes in pitch (the user looking up and down). Accordingly, when determining a deviation value between two orientations/positions V₁, V₂, V₃, V₄, V_{L} any distance in yaw may be weighted more compared to a distance in pitch such that e.g. the selection of a closest listener orientation V₁, V₂, V₃, V₄ to a user orientation V_{L} prioritizes selection of a listener orientation V₁, V₂, V₃, V₄ with a similar yaw orientation over a similar pitch orientation.

The same applies analogously when determining a deviation value for different positions, that e.g. can be represented in a cartesian coordinate system with X-, Y-, Z-directions where position changes in one direction results in a greater perceptual impact on the rendered presentation compared to position changes in another direction. Accordingly, the distances along the different axes may be weighted differently such that a distance along one axis influences the deviation value more compared to distance along another axis.

Additionally, the perceptual weighting may emphasize distances in orientation more than distances in position or vice versa when determining the deviation value. For example, in many implementations, it may be beneficial to provide a greater weight to distances in orientation compared to distances in position since orientation changes may have a greater perceptual effect compared to changes in position. As an example, if the audio assets comprise audio objects that are located at a large distance from the user, small changes in position may have a miniscule perceptual effect whereas small changes in orientation still have a large perceptual effect. Accordingly, when determining a deviation value between the user orientation/position and the listener orientation/position V₁, V₂, V₃, V₄ the deviation value will be mostly depending on differences in orientation.

As explained in the above, determining modified transformation parameters W_{L} comprises determining a deviation value between the user orientation V_{L} and at least one of: a listener orientation/position V₂, V₃, V₄ associated with transformation parameters W2, W3, W4 and the orientation/position V₁ associated with the main presentation R₁ wherein the deviation value is a measure of the linear distance, non-linear distance and/or perceptually weighted distance between the user orientation V_{L} and a listener orientation V₁, V₂, V₃, V₄.

Accordingly, the scale of the axes in FIGS. 2-6 may be linear, non-linear and/or perceptually warped. For instance, the listener orientations/positions V₁, V₂, V₃, V₄ in FIG. 2 may not be uniformly distributed in a linear space since the linear distance in pitch angle between V₁ and V₃ may be much larger compared to the linear distance in yaw angle between V₁ and V₂ even though these distances, with the warped or non-linear axes, appears to be approximately the same.

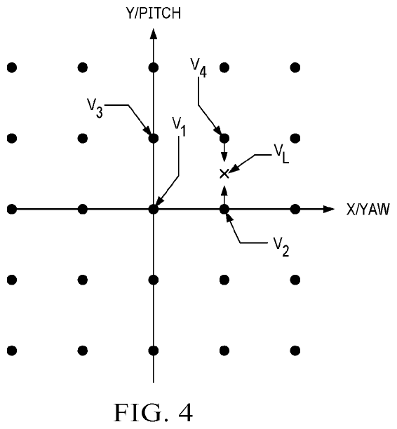

With reference to FIG. 4, determining the transformation parameters associated with an orientation/position V₁, V₂, V₃, V₄ which is the smallest distance (e.g., closest) to the listener orientation/position V_{L} will now be described. If the listener orientation/position V_{L} is closer to (i.e. associated with a smaller deviation value) orientation/position V₂ compared to the other positions V₁, V₂, V₃ the transformation parameters W₂ are selected by the parameter processor 17 which sets W_{L}=W₂. While determining and using the transformation parameters associated with the closest, best matching, orientation/position V₁, V₂, V₃, V₄ is a process which can be made very fast and efficient there may be noticeable acoustic disturbances as the user changes orientation and different transformation parameters are selected. On the other hand, if many transformation parameters have been generated for a fine granularity distribution of orientations/positions V₁, V₂, V₃, V₄, the noticeability of these acoustic disturbances can be mitigated.

Alternatively, determining modified transformation parameters W_{L} may comprise interpolating between the transformation parameters W₂, W₃, W₄ associated with different orientations/positions V₁, V₂, V₃, V₄ based on the user orientation/position V_{L} relative the orientations/positions V₁, V₂, V₃, V₄. For example, as shown in FIG. 4, the user orientation/position V_{L} lies between orientations/positions V₄ and V₂ whereby determining the modified transformation parameters W_{L} comprises interpolating between the parameters W₄ associated with orientation/position V₄ and parameters W₂ associated with orientation/position V₂ based on the deviation value between V_{L} and V₂ as well as the deviation value between V_{L} and V₄.

Accordingly, transformation parameters associated with orientations/positions between the discrete orientations/positions V₁, V₂, V₃, V₄ are accessible via interpolation, such as linear interpolation or using a triangulating interpolation function. The transformation parameters W₁, W₂, W₃, W₄ for each position may all be of the same format. As described in the above, each set of transformation parameters Wₚ may indicate an initial least square solution transformation matrix \hat{M}ₚ or each set of Wₚ may indicate an enhanced transformation matrix Mₚ and a decorrelation gain G_{d,p} which could be used to transform the main presentation.

The main presentation R₁ is associated with orientation/position V₁. However, as it may not be necessary to determine any transformation parameters associated with this orientation/position it is envisaged that the parameter processor 17 may associate position V₁ with default transformation parameters W₁, e.g. W₁={Mₚ, g_{d,p}} wherein Mₚ=1 and g_{d,p}=1 allowing orientation/position V₁, and the associated default transformation parameters W₁, to be used for interpolation. For example, as shown in FIG. 3 the user orientation/position V_{L} may lie between V₁ and V₂ whereby interpolation to find W_{L} is performed by the parameter processor 17 between the default parameters W₁ associated with orientation/position V₁ and parameters W₂ associated with orientation/position V₂ based on the deviation value between V_{L} and V₁ as well as the deviation value between V_{L} and V₁.

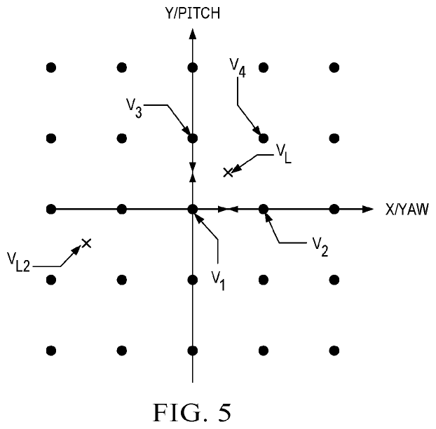

In FIG. 2 and FIG. 3 the user orientation/position V_{L} is exemplified as lying between two orientation/position along a degree of freedom, DOF, axis (e.g. along the X-axis or Yaw-axis as in FIG. 3), however it is understood that the user orientation/position V_{L} may be any orientation/position in a six DOF system meaning that the interpolation could be performed between more than two points. For example, as shown in FIG. 5, the user orientation/position V_{L} may lie between, but separated from, multiple orientation/position V₁, V₂, V₃, V₄ associated with different individual transformation parameters W₁, W₂, W₃, W₄ wherein interpolation is performed between transformation parameters W₁, W₂, W₃, W₄, based on the deviation value between the user orientation/position V_{L} and orientations/positions V₁, V₂, V₃, V₄.

The main presentation R₁ and the transformation parameters W₂, W₃, W₄ may also be transmitted to a second interactive renderer (not shown) implemented in another device separate from the device implementing the first interactive renderer 15. The second interactive renderer performs the corresponding processing as the first interactive renderer 15 but based on the user orientation/position V_{L2} of a second user. That is, the second interactive renderer determines, based on the same transformation parameters W₂, W₃, W₄ a second set of modified transformation parameters that could be used to transform the same main presentation R₁ to a presentation associated with the second user orientation/position V_{L2}. In other words, the distributed rendering system 1 could be used for multi-casting wherein the same audio assets 10 are rendered to multiple users via individual interactive renderers 15 obtaining the orientation of a respective user, but using the same multi-presentation renderer 11 and multi-presentation encoder 13.

After having determined the modified transformation parameters W_{L} (by interpolation or selection of the best matching parameters), the parameter processor 17 provides the transformation parameters W_{L} to a presentation transformer 15 which applies the modified transformation parameters W_{L} to the main presentation R₁ to generate an output presentation. The output presentation may be referred to as an interactive output presentation. Optionally, the output presentation is provided to one or more loudspeakers (e.g. the loudspeakers of a set of earphones or headphones) that present the output presentation to the user.

The transformation parameters W₁, W₂, W₃, W₄ are updated periodically for each (optionally partially overlapping) frame and frequency band and provided to the interactive renderer 15. Similarly, the interactive renderer 15 receives periodic updates of the user orientation/position V_{L} and determines and applies modified transformation parameters W_{L} for each time-frequency tile.

In some implementations, it is desirable to use different formats of the transformations parameters Wₚ for different DOFs. For example, listeners may be less sensitive to inaccuracies in the presented presentation when changing orientation/position in some specific DOFs compared to other DOFs. Especially for rotational orientations, it has been found that listeners are less sensitive to inaccuracies when changing the pitch orientation (e.g., looking up or down) compared to when changing the yaw orientation (e.g., looking left to right). It has been found that with changes of pitch, most of the binaural localization cues, such as interaural time and level differences that users use to localize sounds stays constant, because their perceived positions move along the so called cone of confusion.

The most prominent cue for changes in the pitch lies in the form of changes in the frequency spectrum whereas the most prominent cues for changes in yaw are in the form varying interaural level differences and time delays. Hence, it is envisaged that transformation parameters Wₚ associated with different pitch orientations for a specific yaw orientation are described using less parameters compared to the specific yaw orientations.

For example, transformation parameters Wₚ as described in the above may be determined for a set of principal yaw orientations, wherein the principal yaw orientations have different yaw angles at predetermined pitch angles (e.g. a pitch of zero degrees corresponding to a listener looking horizontally). For at least one of the principal yaw orientations, a set of reduced transformation parameters W_{pitch} is determined for transforming the principal yaw orientation at the predetermined pitch to an accompanying pitch orientation (e.g. a pitch of 15 degrees corresponding to a listener looking up from the horizon). The reduced transformation parameters W_{pitch} comprises, for each frame and frequency band, a gain for each channel in the presentation formation. For example, for a binaural or stereo presentation format, the reduced transformation parameters W_{pitch} comprises a gain g_{pitch,u,l} for the left channel and a gain g_{pitch,u,r} for the right channel for each time-frequency tile and frequency band. If a total of U different accompanying pitch orientations are used for each principal yaw orientation, the gains of the reduced transformation parameters are applied as

$$[ \begin{matrix}{z}_{l , p , u} [ n ] \\ {z}_{r , p , u} [ n ]\end{matrix} ] = [ \begin{matrix}{g}_{pitch , u , l} & 0 \\ 0 & {g}_{pitch , u , r}\end{matrix} ] ( {M}_{p} [ \begin{matrix}{y}_{l , {p}_{o}} [ n ] \\ {y}_{r , {p}_{o}} [ n ]\end{matrix} ] + [ \begin{matrix}\vert {g}_{p , p} \vert \\ {g}_{p , p}\end{matrix} ] Ψ ( {y}_{l , {p}_{o}} [ n ] + {y}_{r , {p}_{o}} [ n ] ) ) \qquad Eq . 21$$

wherein index u=±1, . . . , ± [symbol] indicates the accompanying pitch orientation index for a principal yaw orientation index of p, and u=0 indicates the predetermined pitch angle of the principal yaw orientation. The gains g_{pitch,u,l} and g_{pitch,u,r} constituting the reduced transformation parameters W_{pitch} can e.g. be found as the square root of the ratio of the signal energy level (e.g. the average energy level) of a rendered presentation at accompanying pitch index u and principal yaw index p with the presentation with principal yaw index p and the predetermined pitch for each time-frequency tile.

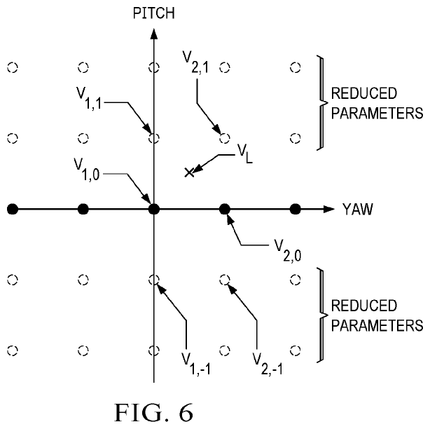

In FIG. 6 it is illustrated schematically a plurality of principal yaw orientations V_{1,0}, V_{2,0} denoted using the format V_{p,u} with p being the yaw angle index and u being the pitch angle index. Each principal yaw orientation V_{1,0}, V_{2,0} is associated with a predetermined pitch (e.g. a pitch of 0 degrees) and respective set of transformation parameters W₁, W₂ for transforming the main presentation R₁. Each set of transformation parameters W₁, W₂ indicates for each time-frequency tile the matrix elements of the initial least square solution transformation matrix \hat{M}ₚ or each set of Wₚ may indicate an enhanced transformation matrix Mₚ and a decorrelation gain G_{d,p} which could be used to transform the main presentation R₁ to a presentation associated with the yaw of the principal yaw orientations V_{1,0}, V_{2,0}.

For each principal yaw orientation V_{1,0}, V_{2,0} at least one set of reduced transformation parameters W_{pitch} is generated, the reduced transformation parameters indicating how the transformation parameters W₁, W₂ of the principal yaw orientations V_{1,0}, V_{2,0} should be modified in order to obtain transformation parameters that transform the transformation parameters W₁, W₂ to a presentation with a different pitch. For instance, the reduced transformation parameters W_{pitch,2,1} and W_{pitch,2,-1} are associated with the accompanying pitch orientation V_{2,1} and V_{2,-1} respectively which in turn are associated with the principal yaw orientation V_{2,0} associated with transformation parameters W₂.

By comparing FIG. 6 with FIG. 5 it seen that for many pitch and yaw orientations reduced transformation parameters W_{pitch} are used instead of parameters Wₚ. Since each set of reduced transformation parameters W_{pitch} comprises only two real valued gain values, namely g_{pitch, u, l} and g_{pitch, u, r} (or in general one for each channel in the presentation format) compared to at least four real valued or complex values for a set of transformation parameters Wₚ much less data is needed to span an equal number of orientations or more orientations can be represented with the same amount of data. At the same time, since the simpler, more data efficient, reduced transformation parameter W_{pitch} are used for spanning the pitch transformation only, for which users are less sensitive, the reduction in data comes with essentially no reduction in the Quality of Experience for users.

In one exemplary implementation, a first and second listener orientation V_{1,0}, V_{2,0} are principal yaw listener orientations at respective predetermined first and second pitch orientations (e.g. a pitch of 0 degrees). The first and second listener orientation V_{1,0}, V_{2,0} are associated with a respective set of (full) transformation parameters W₁, W₂. Optionally, one of the first and second listener orientation V_{1,0}, V_{2,0} is associated with the main presentation and default transformation parameters.

At least one of the first and second listener orientation is associated with a third listener orientation V_{2,1} that has a pitch orientation that is different from the first or second listener position V_{1,0}, V_{2,0} but a yaw orientation that is the same as the first or second listener position. The third listener orientation V_{2,1} is associated with reduced transformation parameters W_{pitch,2,1} having one value per time-frequency tile and channel in the presentation format that can be used to adjust the pitch of the first or second listener orientation V_{1,0}, V_{2,0}. The interactive renderer obtains a user orientation V_{L} and determines an orientation deviation value based on the user orientation V_{L} and the orientation of at least one of the first, second and third listener orientation V_{1,0}, V_{2,0}, V_{2,1} and applies the reduced transformation parameters W_{pitch,2,1} based on the orientation deviation value. For example, it is determined that the user orientation V_{L} is closest to the third listener orientation V_{2,1} wherein the reduced transformation parameters W_{pitch,2,1} associated with this listener orientation are applied to the main rendered presentation R₁. It is noted that the reduced transformation parameters W_{pitch,2,1} may be applied in addition to the full transformation parameters W₂ associated with the second listener orientation V_{2.0}. In general, it is noted that when reduced transformation parameters W_{pitch,2,1} associated with principal transformation parameters W₁, W₂ are used the step of determining the modified transformation parameters W_{L} to apply to the main presentation involves determining a best matching set of principal transformation parameters W₁, W₂ (by selecting a closest set or by interpolation) and for, the best matching set of principal transformation parameters W₁, W₂, determining a best matching set of reduced transformation parameters W_{pitch,2,1}, W_{pitch,2,-1}. The modified transformation parameters W_{L} are obtained as a combination of these best matching sets meaning that the output presentation is obtained by applying the best matching principal transformation parameters W₁, W₂ as well as the best matching reduced transformation parameters W_{pitch,2,1}, W_{pitch,2,-1} to the main presentation R₁.

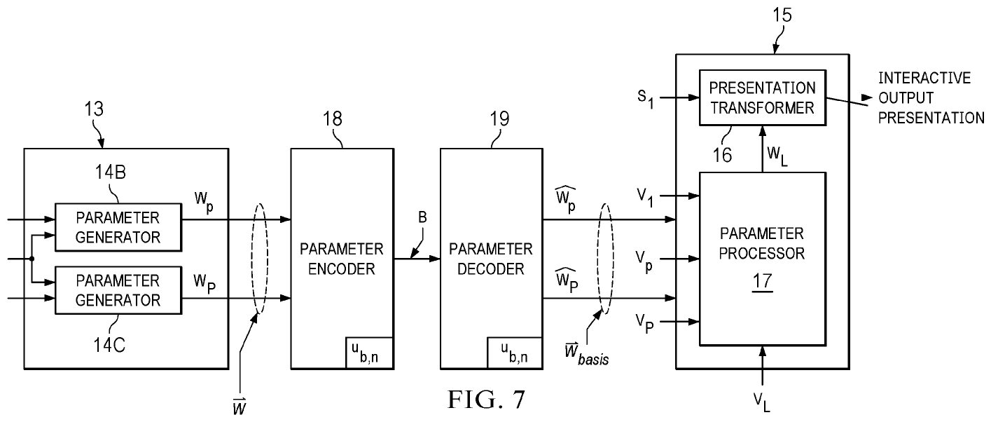

In FIG. 7 the multi-presentation encoder 13 and interactive renderer 15 are shown alongside a parameter encoder 18 and parameter decoder 19. The parameter encoder 18 may be a part of the multi-presentation encoder 13 or provided externally. Similarly, the parameter decoder 19 may be a part of the interactive encoder 15 or provided externally. As exemplified in the above, it is envisaged that the multi-presentation encoder 15 is implemented in a wearable device, e.g. a set of earphones or a set of headphones. As the bandwidth for communicating with a wearable device may be limited (for example the communication may be wireless, such as Bluetooth) it is beneficial if the amount of data transmitted to the interactive renderer 15 is limited. The amount of data may be reduced by using reduced transformation parameters W_{pitch} for some listener positions as explained in the above. As will now be described, the amount of data transmitted to the interactive renderer 15 can alternatively or additionally be reduced using efficient encoding and decoding of the transformation parameters Wₚ, W_{pitch} prior to and after transmission.

The parameter encoder 18 obtains the transformation parameters W₁, . . . , W_{P} (optionally including one or more sets of reduced transformation parameters W_{pitch}) associated with respective positions V₁, . . . , V_{P}. The sets of transformation parameters (as well as any reduced transformation parameters) W₁, . . . , W_{P} are combined into a vector [symbol] and, for time-frequency tile based processing, a vector [symbol] will be generated for each time-frequency tile. For example, if three sets of transformation parameters Wₚ are to be transmitted to the interactive renderer, and each set of transformation parameters comprises four complex values and one real value, the vector [symbol] will comprise 27 vector elements. It is optional to include any default transformation parameters W₁ associated with the main presentation R₁ since these may already be stored in the interactive renderer 15.

For each frequency band b, a plurality of predetermined basis vectors u_{b,n} may be used by the parameter encoder 18 to approximate vector [symbol] . In total, there are No basis vectors for each frequency band meaning that index n=1, . . . , N_{b}. The number of basis vectors N_{b} may be the same across all frequency bands or it is envisaged that different numbers of basis vectors could be used for different frequency bands. For example, for lower frequency bands fewer basis vectors could be used.

Using the basis vectors u_{b,n} the parameter encoder 18 determines a linear combination of basis vectors forming a vector [symbol] _{basis} which approximates [symbol] wherein

$${\vec{W}}_{basis} = {\sum }_{n = 1}^{{N}_{b}} {α}_{n} {u}_{b , n} \qquad Eq . 22$$

where αₙ is a real valued coefficient. The basis vectors u_{b,n} are determined beforehand using e.g. Principal Component Analysis or similar data reduction methods that enable a full vector to be approximated using a smaller set of coefficients αₙ. The number of basis vectors N_{b}, and real valued coefficients αₙ, is smaller compared to the number of elements in the vector [symbol] .

While it is possible to determine basis vectors u_{b,n} that can accurately reconstruct the vector [symbol] the parameter encoding performed by the parameter encoder 18 will in general not be lossless. On the other hand, in some implementations a residual vector [symbol] is also determined by the parameter encoder 18 such that

$$\vec{W} = \vec{R} + {\sum }_{n = 1}^{{N}_{b}} {α}_{n} {u}_{b , n} . \qquad Eq . 23$$

To this end, it is possible to selectively omit the residual vector [symbol] when bandwidth is limited and transmit [symbol] , or at least a portion thereof, when the bandwidth allows. Accordingly, if the bandwidth for communicating with the interactive renderer 15 allows, the coefficients αₙ and residual vector [symbol] can be transmitted to the interactive renderer 15 allowing perfect reconstruction of the vector [symbol] .

The coefficients αₙ, and optionally the residual vector [symbol] , are included in a bitstream B which is transmitted from the parameter encoder 18 to the parameter decoder 19. The parameter decoder 19 has the predetermined basis vectors u_{b,n} stored and reconstructs the vector [symbol] _{basis} using the received coefficients and equation 22 above. Optionally, if the residual vector [symbol] is also available, the parameter decoder 19 reconstructs the true transformation vector [symbol] using equation 23 above. The reconstructed vector [symbol] _{basis} indicates a reconstruction of the transformation parameters Ŵₚ, which the parameter processor 17 can use to form modified reconstruction parameters W_{L}. Alternatively, if [symbol] can be reconstructed, [symbol] indicates the original transformation parameters W₁, . . . . W_{P}.

In some implementations, data indicating the orientations/positions V₁, . . . . V_{P} associated with transformation parameters W₁, . . . . W_{P} is transmitted alongside the transformation parameters. For example, the data indicating the orientations/positions V₁, . . . . V_{P} can be incorporated into the vector [symbol] or encoded separately. For example, the number and relative orientation/position of rendering orientations/positions V₁, . . . . V_{P} for which the transformation parameters W₁, . . . . W_{P} have been determined may vary over time. It is also envisaged that the positions V₁, . . . . V_{P} may be predetermined and available, e.g. stored locally, on the interactive renderer 15 as mentioned in the above.

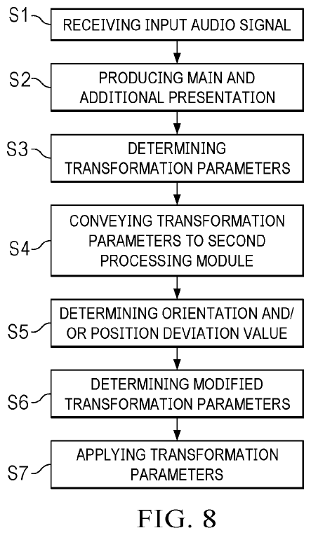

FIG. 8 depicts a flow chart describing a method for processing audio according to some implementations. With further reference to FIG. 1 the method comprises receiving, at a second processing module, at least one input signal at step S1. The first processing module may be the multi-presentation renderer 11 which receives one or more input audio signal from a database 10 with audio assets. The method then goes to step S2 comprising producing a main rendered presentation R₁ based on the at least one input audio signal and producing at least one additional presentation R₂, . . . , R_{P} with P≥2. The main presentation R₁ and the at least one additional presentation R₂, . . . , R_{P} are associated with different respective listener orientations V₂, . . . , V_{P}.

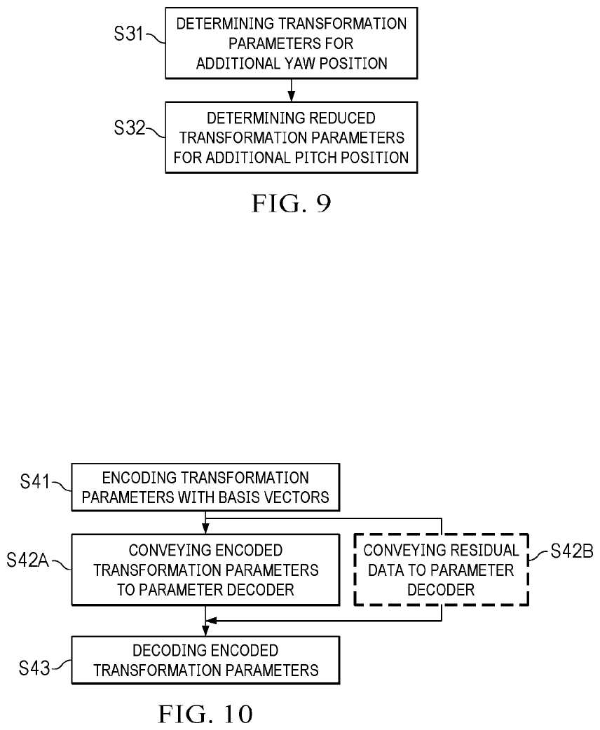

At step S3 a set of transformation parameters W₂, . . . , W_{P} is determined for each additional presentation R₂, . . . , R_{P}. Each set of transformation parameters W₂, . . . , W_{P} being configured to modify the main presentation R₁ into the additional presentation Wₚ. With further reference to FIG. 9, it is envisaged that that step S3 involving determining transformation parameters may comprise step S31 comprising determining transformation parameters Wₚ for an additional presentation, wherein the additional presentation is associated with a different yaw orientation compared to the main presentation and step S32 comprising determining reduced transformation parameters W_{pitch} for a second additional presentation which is associated with the same yaw orientation as the additional presentation but a different pitch orientation. That is, the method comprises determining one or more sets of transformation parameters spanning a range of different principal yaw orientations with a predetermined pitch and subsequently determining, for at least one of the principal yaw orientations, one or more reduced sets of transformation parameters W_{pitch} describing how a presentation at the principal yaw orientation with the predetermined pitch may be transformed to a presentation with the same yaw orientation but a different pitch. The reduced set transformation parameters of transformation parameters indicates a real valued gain for each channel, whereas the (non-reduced) set of transformation parameters indicates at a least an N-by-N matrix, N being the number of channels in the presentation.

Turning back to FIG. 8, the method then goes to step S4 comprising conveying the transformation parameters and the main presentation R₁ to a second processing module. The second processing module may implement an interactive renderer 15 as described in the above. The interactive renderer 15 obtains user orientation/position data indicating the user orientation/position V_{L} or at least the orientation/position of a user's head.

At step S5 the interactive renderer 15 determines an orientation/position deviation value between the orientation of the user and the listener positions V₁, . . . , V_{P} associated with the main presentation R₁ and the transformation parameters W₂, . . . , W_{P}. Based on this orientation/position deviation value, the interactive renderer 15 determines at step 86 modified transformation parameters W_{L} that shift the main presentation R₁ from the first listener orientation/position V₁ to the user orientation/position V_{L}. Determining the modified transformation parameters W_{L} may comprise selecting a set of transformation parameters Wₚ associated with an orientation/position Vₚ that is closest to the user orientation/position V_{L} or interpolating between at least two sets of transformation parameters Wₚ, . . . , W_{P} associated with listener orientations/positions in the proximity of the user orientation/position V_{L}.

At step S7 the modified transformation parameters W_{L} are applied to the main presentation R₁ to form the output presentation.

To facilitate efficient, low bitrate, communication between the first and second processing module it is beneficial if the transformation parameters W₂, . . . , W_{P} are encoded in an efficient manner. FIG. 10 is a flowchart showing a detailed embodiment step S4 from FIG. 8 according to some implementations. The transformation parameters W₂, . . . , W_{P} are combined into a vector [symbol] . At step S41 the vector [symbol] describing the transformation parameters is approximated by a linear combination of predetermined basis vectors u_{b,n}. This approximation, indicated by a set of coefficients αₙ, may be referred to as encoding the vector [symbol] with basis vectors u_{b,n}. The number of basis vectors u_{b,n} is smaller than the number of elements in the vector [symbol] meaning that the scalars an may represent a non-perfect reconstruction of [symbol] referred to as [symbol] _{basis}.

At step S42a the scalars αₙ are transmitted to the second processing module. Optionally, at step S42b a residual vector [symbol] is determined describing the difference between [symbol] referred to as [symbol] _{basis} and transmitted to the second processing module.

At the second processing module, the scalars αₙ (and optionally the residual vector [symbol] ) are used to reconstruct [symbol] _{basis} (or [symbol] , if [symbol] is available) at step S43 using the same predetermined basis vectors u_{b,n}. The process of reconstructing [symbol] _{basis} or [symbol] may be referred to as decoding the encoded transformation parameters.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described specific embodiments of the invention, those skilled in the art will recognize that other and further modifications may be made thereto without departing from the spirit of the invention, and it is intended to claim all such changes and modifications as falling within the scope of the invention.

Various aspects of the present invention may be appreciated from the following Enumerated Example Embodiments (EEEs):
EEE 1.1. A method of processing audio, comprising: receiving, at a first processing module, an audio input comprising audio channels, objects, metadata, or a combination thereof; producing, at the first processing module, one or more rendered presentations of the audio input and presentation transformation data; receiving, at a second processing module, user interactivity data and said one or more rendered presentations and presentation transformation data generated by said first process; and generating, at the second processing module, an output presentation in response to received user interactivity data, rendered presentations and presentation transformation data.

EEE 1.2. A method according to EEE 1.1, in which the output presentation is configured for headphones playback.

EEE 1.3. A method according to EEE 1.1 or 1.2, in which the user interactivity data is indicative of the user's head orientation or position.

EEE 1.4. A method according to any of the previous EEEs, in which the two processing modules are implemented on different devices with different processing capabilities and/or processing latency.

EEE 1.5. A method according to any of the previous EEEs, in which the presentation transformation data represents a gain or input-output matrix that has real or complex-valued coefficients.

EEE 1.6. A method according to any of the previous EEEs, in which processing is applied as a function of time and frequency.

EEE 1.7. A method according to EEE 1.1, in which the first process is split into two sub-processes, first sub-process being a renderer that renders multiple presentations, and second sub-process to generate presentation transformation data.

EEE 1.8. A method according to any of the previous EEEs, in which the second process includes a decorrelator stage, said decorrelator stage output being mixed into the output presentation by a gain that is dependent on the presentation transformation data.

EEE 1.9. A method according to any of the previous EEEs, in which the user interactivity data includes (representations of) the user's head yaw and pitch angle, and said presentation transformation data contains data elements for two or more yaw and/or pitch angles.

EEE 1.10. A method according to EEE 1.9, in which the data elements for yaw and pitch angles are represented as yaw and pitch contributions, individually.

EEE 1.11. A method according to any of the previous EEEs, in which the presentation transformation data are represented by means of a pre-determined set of basis functions and a set of basis function weights.

1. A method of processing audio, comprising:
receiving, at a first processing module, at least one input audio signal;
producing, at the first processing module, a main rendered presentation and an additional rendered presentation, each rendered presentation being associated with a first and second listener orientation and/or position, respectively;
determining, at the first processing module, transformation parameters for transforming the main rendered presentation to the additional rendered presentation;
receiving, at a second processing module, the transformation parameters and the main rendered presentation generated by the first processing module;
receiving, at the second processing module, user orientation and/or position data indicating the orientation and/or position of a user;
determining, at the second processing module, a deviation value based on the orientation and/or position of the user and at least one of the first and second listener orientation and/or position;
determining, at the second processing module, modified transformation parameters based on the transformation parameters and the deviation value; and
applying, at the second processing module, the modified transformation parameters to the main rendered presentation to generate an output presentation associated with the orientation and/or position of the user.

2. The method according to claim 1, wherein determining, at the first processing module, transformation parameters comprises:
determining, at the first processing module, a transformation matrix [symbol] with N-by-N elements, N being the number of audio channels in the main and additional rendered presentation, the transformation matrix [symbol] indicating a linear combination of the audio channels in the main rendered presentation that resembles the additional rendered presentation.

3. The method according to claim 2, wherein determining the transformation matrix [symbol] comprises:
minimizing the error between the additional rendered presentation and the main rendered presentation transformed with the transformation matrix [symbol] .

4. The method according to claim 2, wherein the elements of the transformation matrix [symbol] are real or complex values.

5. The method according to claim 2, wherein determining, at the first processing module, transformation parameters further comprises:
determining an enhanced modified transformation matrix M_{P} which is equal to the transformation matrix [symbol] modified with a diagonal gain matrix G, the diagonal gain matrix G being based on a difference between the covariance of the main rendered presentation modified with the transformation matrix [symbol] and the covariance of the additional rendered presentation.

6. The method according to claim 1, wherein the modified transformation parameters defines N decorrelation gains, N being the number of audio channels in the main and additional rendered presentation, the method further comprising:
processing, at the second processing module, the main rendered presentation with a decorrelator to obtain a decorrelated main rendered presentation; and applying the modified transformation parameters comprises:
applying the decorrelation gains to each channel of decorrelated main rendered presentation.

7. The method according to claim 6, wherein the decorrelated main rendered presentation is a combination of all channels of the main rendered presentation processed with the decorrelation processor.

8. The method according to claim 6, wherein the decorrelation gains are based on the covariance of the main rendered presentation modified with the transformation matrix [symbol] and the covariance of the additional rendered presentation, and wherein the first and second listener orientation and/or position differ in at least one of pitch, yaw and roll orientation.

9. The method according to claim 1, wherein the first and second listener orientation and/or position differ in at least one of pitch, yaw and roll orientation.

10. The method according to claim 1, wherein the first and second listener orientation and/or position are different yaw orientations at respective first and second pitch orientations, further comprising:
obtaining, at the second processing module, reduced transformation parameters associated with a third pitch orientation, the reduced transformation parameters being configured to transform the main rendered presentation or the additional rendered presentation to a pitched rendered presentation with the third pitch orientation; and
applying, at the second processing module, based on the orientation deviation value, the reduced transformation parameters to the main rendered presentation to generate the output presentation.

11. The method according to claim 10, wherein the reduced transformation parameters comprises a real-valued gain for each audio channel of the output presentation.

12. The method according to claim 10, wherein obtaining reduced transformation parameters comprises obtaining separate sets of reduced transformation parameters for each of a plurality of frequency bands, and wherein applying the reduced transformation parameters comprises:
applying the reduced transformation parameters of each frequency band to a corresponding frequency band of the main rendered presentation.

13. The method according to claim 10, wherein applying, based on the orientation deviation value, the reduced transformation parameters to the main rendered presentation comprises:
determining, at the second processing module, modified reduced transformation parameters based on the reduced transformation parameters and the orientation deviation value; and
applying, at the second processing module, the modified reduced transformation parameters to the main rendered presentation to generate the output presentation.

14. The method according to claim 13, wherein the reduced transformation parameters comprises:
main reduced transformation parameters for transforming the main rendered presentation at the first yaw and first pitch orientation to a main pitch presentation at the first yaw and third pitch orientation, and
additional reduced transformation parameters for transforming the additional rendered presentation at the second yaw and second pitch orientation to an additional pitch presentation at the second yaw and third pitch orientation, the method further comprising:
determining, at the second processing module, the modified reduced transformation parameters based on the main reduced transformation parameters, the additional reduced transformation and the orientation deviation value.

15. The method according to claim 13, wherein determining modified reduced transformation parameters comprises:
interpolating between the main and additional reduced transformation parameters based on the orientation deviation value.

16. The method according to claim 13, wherein the first and second pitch orientations are associated with default reduced transformation parameters and determining modified reduced transformation parameters comprises:
interpolating between the default reduced transformation parameters and the reduced transformation parameters based on the orientation deviation value.

17. The method according to claim 1, further comprising:
encoding, at the first processing module, the transformation parameters as coefficients associated with a predetermined set of basis vectors; and
decoding, at the second processing module, the encoded transformation parameters using the predetermined set of basis vectors.

18. The method according to claim 17, wherein the basis vectors are determined via Principal Component Analysis.

19. The method according to claim 17, further comprising:
determining, at the first processing module, a residual vector indicating a difference between the encoded transformation parameters and the transformation parameters;
truncating, at the first processing module, the residual vector; and
decoding, at the second processing module, the encoded transformation parameters using the predetermined set of basis vectors and the truncated residual vector.

20. The method according to claim 1, wherein the output presentation is configured for headphones playback.

21. The method according to claim 1, wherein the transformation parameters comprises different transformation parameters for each of a plurality of frequency bands.

22. The method according to claim 1, further comprising:
producing, at the first processing module, a second additional rendered presentation, the second additional rendered presentation being associated with a third listener orientation and/or position, determining, at the first processing module, second transformation parameters for transforming the main rendered presentation to the second additional rendered presentation;
receiving, at a second processing module, the second transformation parameters generated by the first processing module; and
determining, at the second processing module, modified transformation parameters based on the transformation parameters, the second transformation parameters and the deviation value.

23. The method according to claim 22, wherein determining the modified transformation parameters comprises:
interpolating between the transformation parameters and the second transformation parameters based on the deviation value.

24. The method according to claim, wherein the main rendered presentation is associated with a default main transformation parameters and wherein determining modified transformation parameters comprises:
interpolating between the transformation parameters and the default main transformation parameters based on the deviation value.

25. The method according to claim 1, wherein first and second processing modules are implemented on different devices with different processing capabilities and/or processing latency.

26. The method according to claim 25, wherein the second processing module is a wearable device such as headphones, earphones, wireless earbuds, true wireless earbuds, smart glasses or VR/AR/XR headsets.

27. The method according to claim 1, further comprising:
receiving, at an additional processing module, the transformation parameters and the main rendered presentation generated by the first processing module;
receiving, at the additional processing module, user orientation and/or position data indicating the orientation and/or position of a second user;
determining, at the additional processing module, a second deviation value between the orientation and/or position of the second user and the first and second listener orientation and/or position;
determining, at the additional processing module, second modified transformation parameters based on the transformation parameters and the second deviation value; and
applying, at the additional processing module, the second modified transformation parameters to the main rendered presentation to generate a second output presentation associated with the orientation and/or position of the second user.

28. The method according to claim 1, wherein determining the deviation value includes weighting different angular components of respective user and listener orientation and/or positions differently based on an expected perceptual impact on the rendered presentation.

29. The method according to claim 1, wherein determining the deviation value includes weighting different linear components of respective user and listener orientation and/or positions differently based on an expected perceptual impact on the rendered presentation.

30. The method according to claim 1, wherein determining the deviation value includes weighting linear and angular components of respective user and listener orientation and/or positions differently based on an expected perceptual impact on the rendered presentation.

31. A computer program product comprising instructions which, when the program is executed by a computer, causes the computer to carry out the method according to claim 1.

32. A computer-readable storage medium storing the computer program according to claim 31.

33. A system comprising a first processing module communicating with a second processing module, wherein the first and second processing modules are configured to carry out the method according to claim 1.

34. The system according to claim 33, wherein the first and second processing module are implemented on different devices, the different devices being configured to communicate over wireless and/or wired connection.
